(19) United States
(12) Patent Application Publication
(10) Pub. No.: US 2006/0182525 A1
(43) Pub. Date: Aug. 17, 2006

(54) Loading and unloading station in a sea port or river port

(75) Inventors: Joachim Kroll, Juchen (DE); Hermann Franzen, Monchengladbach (DE); Mathias Dobner, Rommerskirchen (DE)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(73) Assignee: Gottwald Port Technology GmbH

(21) Appl. No.: 10/534,600

(22) PCT Filed: Feb. 12, 2004
(86) PCT No.: PCT/EP04/01291

§ 371 Date: Oct. 28, 2005

(30) Foreign Application Priority Data
Feb. 22, 2003 (DE) 103 07 579.8

(51) Int. Cl. B65G 67/60

(52) U.S. Cl. 414/139.9

(57) ABSTRACT

The invention relates to a loading and unloading station comprising a container terminal that consists of storage modules (8). Each storage module (8) is provided with at least one elevated stacker crane (7) that receives, horizontally conveys, and stacks the containers (17). Said stacker crane (7) cooperates with transversal transporters (18) which can be displaced perpendicular to the storage modules (8) on a different horizontal plane so as to horizontally convey the containers (17) between the storage modules (8). In order to increase the loading and unloading capacity of such an automated container terminal, a number of more than two transversal transporters (18) can be moved on at least one rail track located on one and the same plane that lies below the plane of conveyance of the stacker cranes (7) and above loading lanes for trucks (9), into the area of intermediate storage facilities (16) which are allocated to one respective storage module (8), are placed laterally parallel to the rail track of the transversal transporters (18), and form interfaces between the stacker crane (7) and the transversal transporters (18), the number of the transversal transporters depending on the size of the container terminal.

The invention concerns a handling facility at a seaport or inner harbor, especially for ISO containers, with a container terminal arranged alongside a wharf, consisting of individual storage modules arranged in rows, and at least one loading facility interacting with the storage modules for the cargo handling to and from a ship lying at the wharf, wherein at least one elevated stacking crane per storage module takes charge of the receiving, the horizontal transporting, and the stacking of the containers and interacts with cross transporters acting independently of each other and able to travel on a different horizontal level transverse to the individual storage modules, being responsible for the horizontal transporting of containers between the storage modules.

For the handling of ISO containers between various kinds of means of transportation, such as ships, trains or trucks, loading facilities are used that must ensure a largely trouble-free handling of less than cargo lots with high throughput rate. The central component of a container handling facility is usually a container yard, which breaks up the streams of less than cargo lots and thereby ensures that the various means of transportation are serviced as needed. Servicing of the various types of transportation according to their arrival and needs requires an optimized layout of the entire handling facility.

A container yard of this category is known from DE-A-100 02 915. The loading boom of a mobile harbor crane extends from the region of the ship being unloaded into the region of at least one transfer station, forming an interface between the mobile harbor crane and the storage modules of the container yard, where the container is put down. At least one stacking crane per storage module, which is monitored and controlled by an executive yard logistics system, picks up the container that was put down by the mobile harbor crane at the particular transfer station and undertakes thereafter the horizontal transport and the stacking of the container in the container yard. In this way, it is possible to eliminate the horizontal transport between ship and container yard that occurs in traditional automated facilities and that usually is accomplished with manual or automated transport vehicles. The stacking crane itself is conventionally configured as an elevated bridge crane with a trolley and it typically spans one storage module of the container yard. Preferably, the familiar container yard is divided into at least two regions centrally to the container yard, depending on the characteristics of the yard, and the stacking cranes travel across both regions.

The storage modules of the familiar container yard are joined together by means of two cross transporters, acting independently of each other and able to travel on different horizontal levels transverse to the individual storage modules, which are likewise monitored and controlled by the executive yard logistical system. In this way, the fully automatic stacking cranes operating in the individual storage modules can transport the containers either directly from the transfer stations to the corresponding storage modules or to one of these two cross transporters. The cross transporters either actuate a different storage module or exit points where the containers enter and exit trucks.

The above-described container yard system is especially well suited and designed to enable a fully automatic operation of the terminal even by operators of rather small handling facilities. However, the handling efficiency of the terminal is greatly limited by the only two cross transporters that can be used, especially when one cross transporter is blocked by intersections when one cross transporter is traveling and at the same time the other cross transporter is being loaded by the stacking crane. For larger facilities, this constitutes a sizable disadvantage, limiting the throughput efficiency and the availability of the loading equipment.

Starting from a handling facility as described above, the problem of the present invention is to substantially increase the handling efficiency and the performance of an automated container terminal.

To solve this problem, a handling facility of the generic type is proposed, being characterized in that a number of more than two cross transporters, depending on the size of the container terminal, can move on the same level beneath the transport level of the stacking cranes and above the truck loading lanes on at least one railway extending transversely to the storage modules into the region of interim storage stations assigned to each storage module, each of them being arranged sideways and parallel to the railway of the cross transporter and forming interfaces between the stacking crane and the cross transporters. According to the invention, the number of cross transporters in the compact container terminal is increased, thereby enhancing the handling efficiency at this point. The cross transporters move on a single level, i.e., there is no longer any overlapping with one cross transporter moving and another cross transporter being loaded by the crane at the same time. The interim storage station that forms the interface between stacking crane and cross transporter can hold several containers per storage module. Stacking crane and cross transporter operate entirely independently of each other. The loading and unloading of trucks is possible over the entire region of the terminal at the loading lanes. The performance of the overall terminal is enhanced.

According to one favorable feature of the invention, each cross transporter is outfitted with a transfer or receiving device for handling of a container to or from an interim storage station. As a result, the cross transporter is not loaded directly by the stacking cranes, but instead is serviced from the interim storage station, which is arranged parallel to the railways.

In one embodiment of the invention, the transfer or receiving device consists of a load carrier for the container that can shift or travel transverse to the direction of travel of the cross transporter into the region of the interim storage station. Preferably, the load carrier is designed as a linear propelled shunt car, which can travel on a railway arranged on the cross transporter. The linear propulsion can come from any conventional drive unit, such as chain drive, rack and pinion gear, piston and cylinder units, or the like.

In order to enable a smooth transfer of the container placed on a load carrier to the interim storage station, according to another feature of the invention the interim storage stations configured as angle brackets reach freely at least in part across the railway and the cross transporter, so that the load carrier can travel underneath the interim storage station when the cross transporter is positioned beneath the interim storage station, and open slots running sideways are provided in the angle brackets in the direction of the load carrier, which are engaged by vertical lifting devices for the container that are arranged on the load carrier and that reach underneath the support points of the container. Preferably, the vertical lift devices of the load support are configured as hydraulic piston and cylinder units, which are arranged at the standard spacing of the corner fittings of ISO containers on the load support.

The load supports take up two end positions on the cross transporters. In the first end position, in which the load supports are located underneath the interim storage station configured as angle brackets, the containers are lifted up or set down in the interim storage station by activating the hydraulic load supports. Only when the load carrier has arrived at its second end position alongside the interim storage station by linear shifting on the cross transporter and the load supports have been hydraulically lowered can the cross transporter proceed, with or without a container.

An especially high handling efficiency can be achieved when, according to an especially important feature of the invention, two railways running parallel to each other traverse the container yard transverse to the storage modules, and are joined together at the head side by change-over devices for the cross transporters, in order to enable a switching of the cross transporters from one of the railways to the other parallel railway. Thanks to this arrangement, both railways can be optimally utilized in closed circuit, and the cross transporters traveling on a common level and in a fixed direction of turning cover the entire width of the yard and reach any given storage module, and at the end points on the top side of the railways they can be switched to return on the parallel railway. The cross transporter itself is not loaded directly by the stacking crane, but is automatically serviced from the interim storage stations, which are arranged parallel to the railways.

Because the railways travel across the entire width of the container yard, the truck driving lanes according to the invention can travel underneath the railways and the truck loading lanes can travel underneath next to the interim storage stations. In this way, loading and unloading of trucks is possible at the loading lanes over the entire width of the terminal.

According to the invention, the change-over devices each consist of a bridge-like steel structure with lengthwise running rails, whose gauges correspond to those of the railways for the cross transporters, and are outfitted with rail travel mechanisms at the front end, which can travel on elevated railways transverse to the railways of the cross transporters at the head side and between the two parallel railways of the cross transporters and move into end positions where the rails on the bridge-like steel structure are aligned with one of the railways for the cross transporters.

Since the cross transporter should drive onto and off from the change-over device as jolt-free as possible, before the cross transporter passes over, the gaps provided between the railways of the cross transporter and the change-over device are automatically closed with corresponding horizontally and vertically positioned adapters.

Preferably, the interim storage stations are secured with the vertical legs of the angle brackets to the side of the girders for the railways and are designed to accommodate up to four containers per storage module. In this way, a sufficient buffer function of the interim storage station is achieved.

The novel handling facility for a container terminal at seaport or inner harbor satisfies the indicated conditions. Within the container terminal, a continuous distribution of the containers to all storage modules is possible by means of cross transporters. A rather large number of cross transporters travels on preferably two parallel railways with two change-over devices at the head stations, which enable a switching of the cross transporters and improve their availability. The cross transporters are timed to travel in a single fixed direction of turning and on the same horizontal level. The cross transporters are not directly loaded by the stacking cranes, they are automatically serviced from the interim storage stations, which are arranged parallel to the railways. There are at least four truck loading and driving lanes underneath the railways and the interim storage stations, so that a large number of trucks can be serviced at the same time.

In summary, the following benefits over the state of the art result:
a) The number of cross transporters in the compact container terminal is increased, thereby increasing the handling efficiency at this point.
b) The cross transporters move on the same level, i.e., there is no longer any intersecting with one cross transporter moving and the second cross transporter being loaded by the stacking crane at the same time.
c) At least four containers per storage module can be waiting at the interim storage station, which forms the interface between stacking crane and cross transporter.
d) Stacking crane and cross transporter operate independently of each other.
e) The loading and unloading of the trucks is possible at the loading lanes across the entire zone of the terminal.
f) The performance of the entire terminal is improved.

A sample embodiment of the invention is depicted in the drawing and shall be described hereafter. It shows:

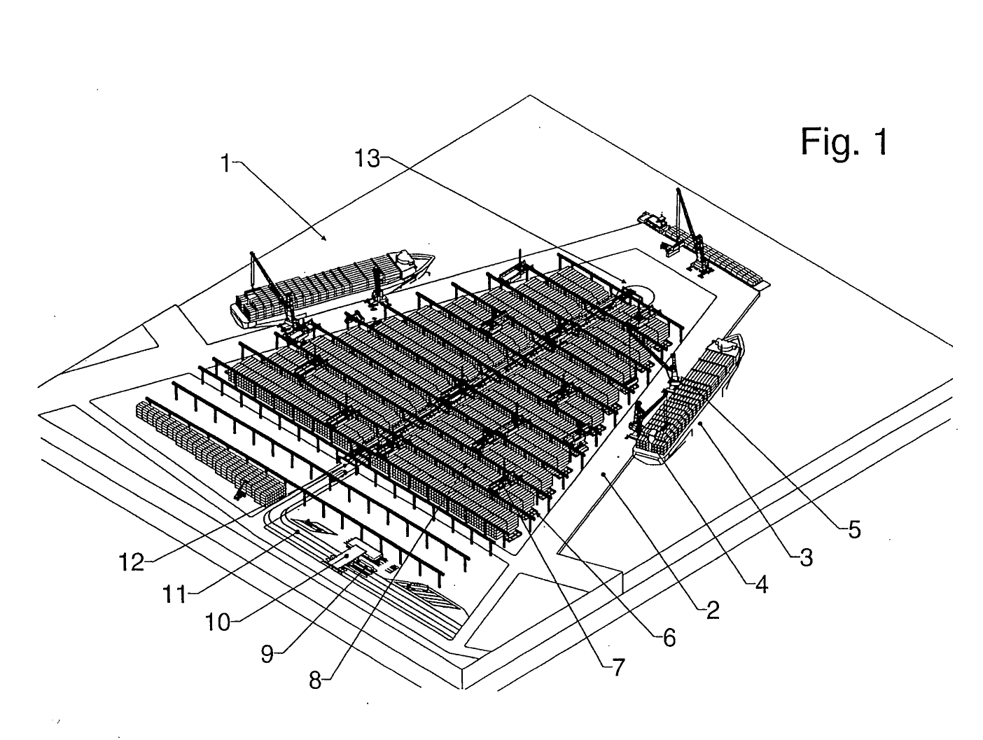

FIG. 1, a layout of a container terminal according to the invention,

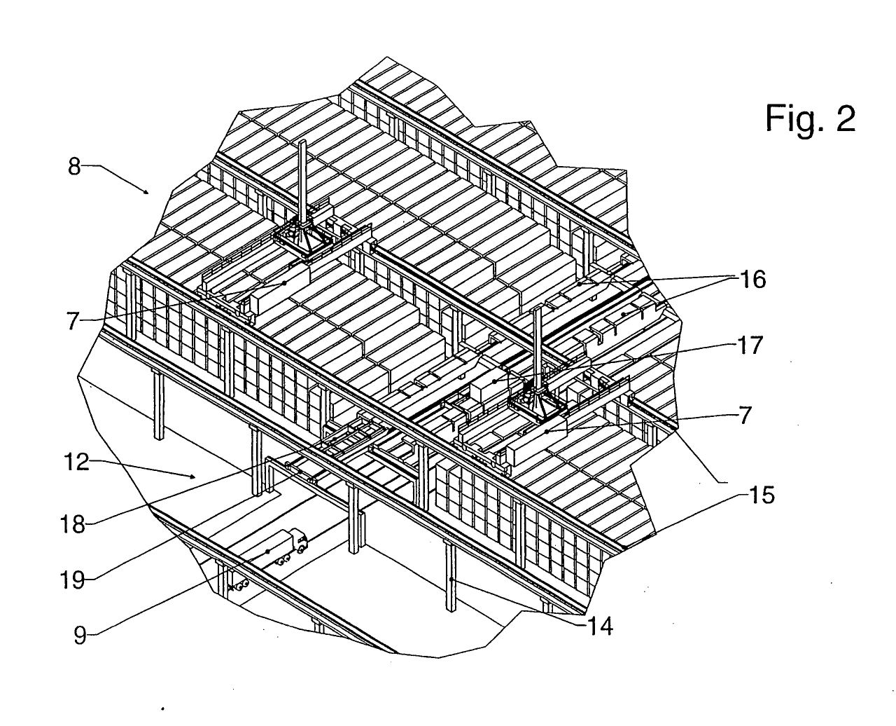

FIG. 2, a detail of FIG. 1 from the region of the yard entrance and exit,

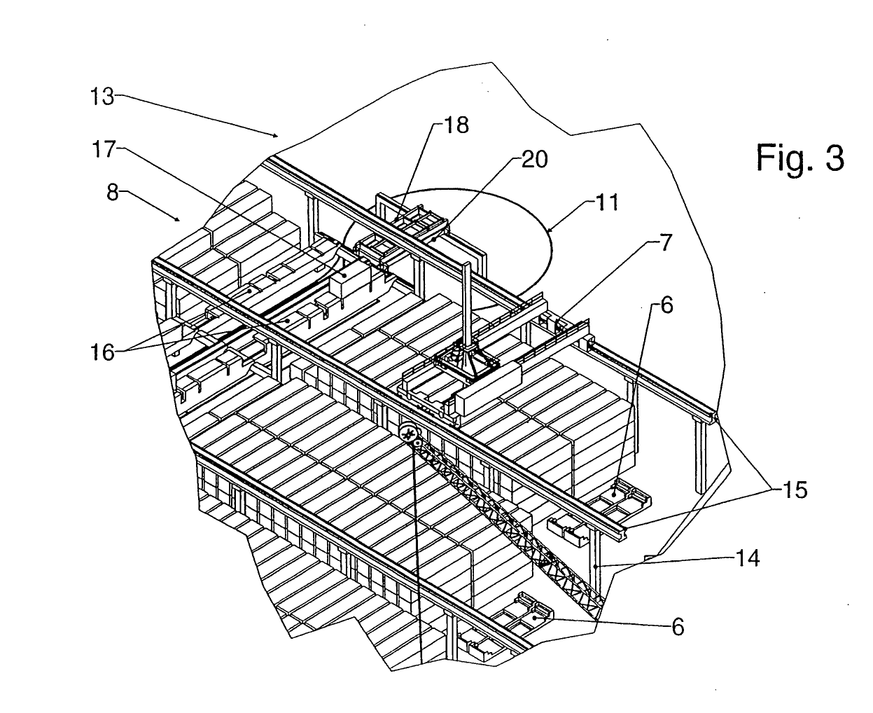

FIG. 3, a detail of FIG. 1 from the zone of the truck turning station,

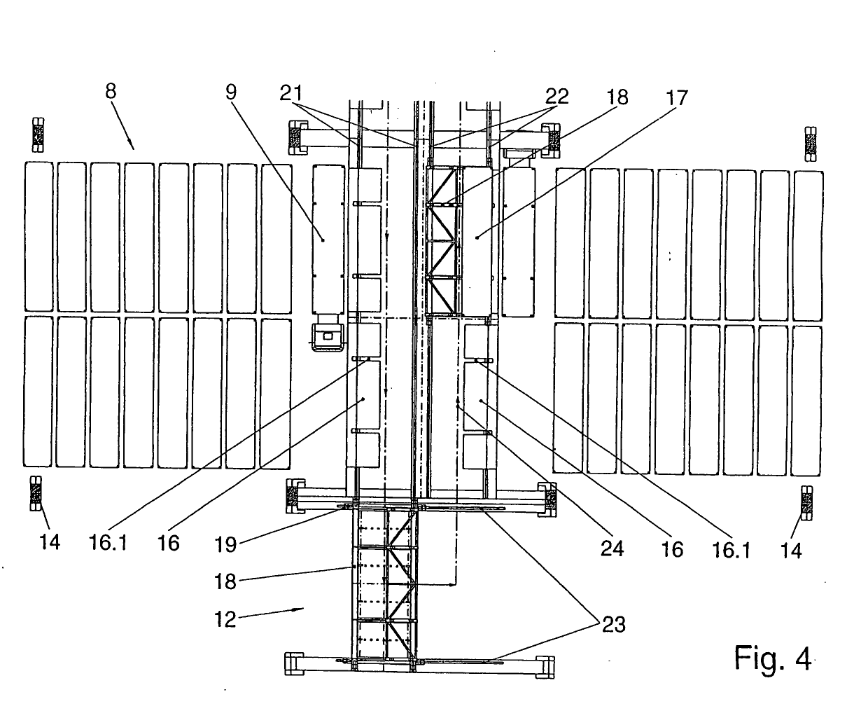

FIG. 4, a detail of FIG. 1 as a top view of the region of the yard entrance or exit,

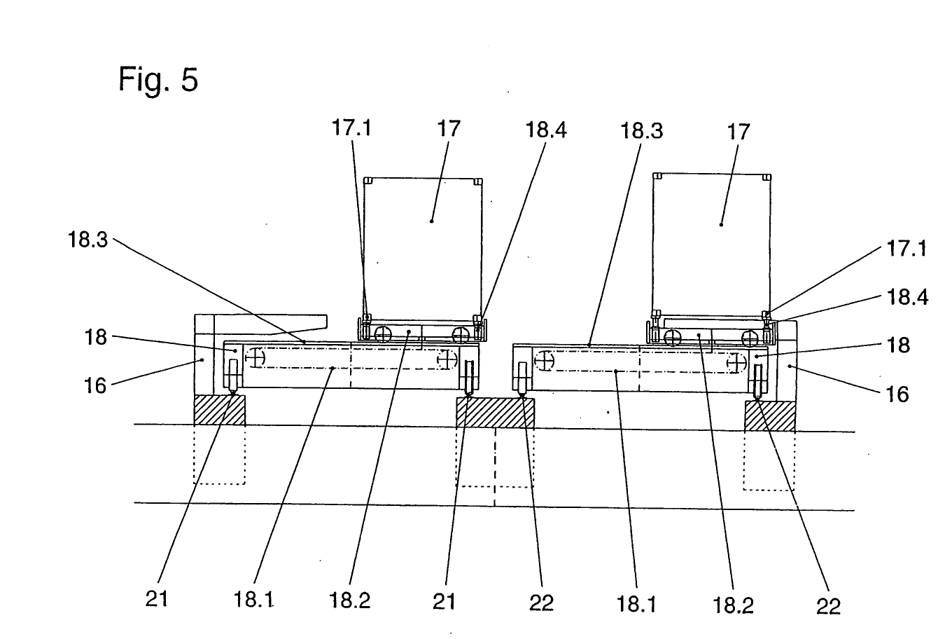

FIG. 5, a cross section through the interim storage station and a view of the cross transporter,

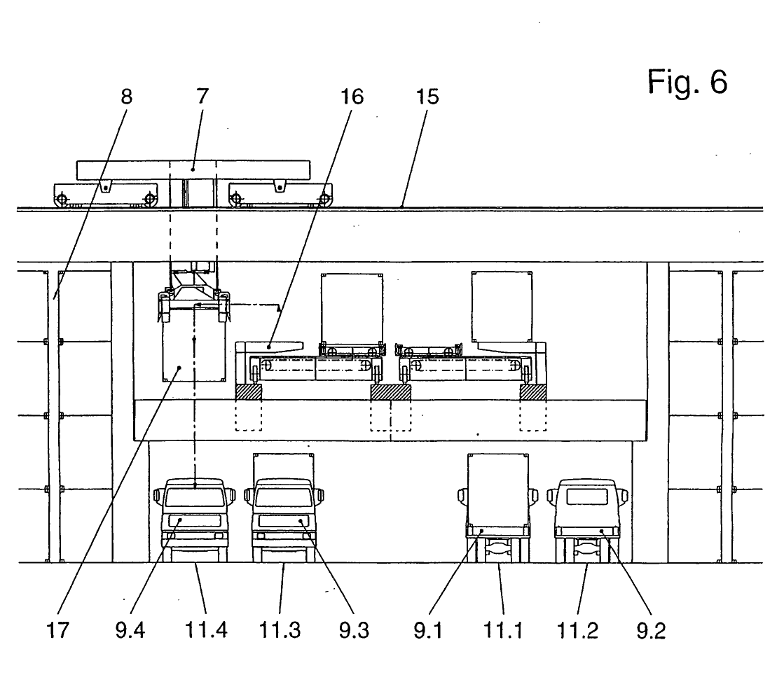

FIG. 6, a cross section through the loading and unloading zone in the container yard,

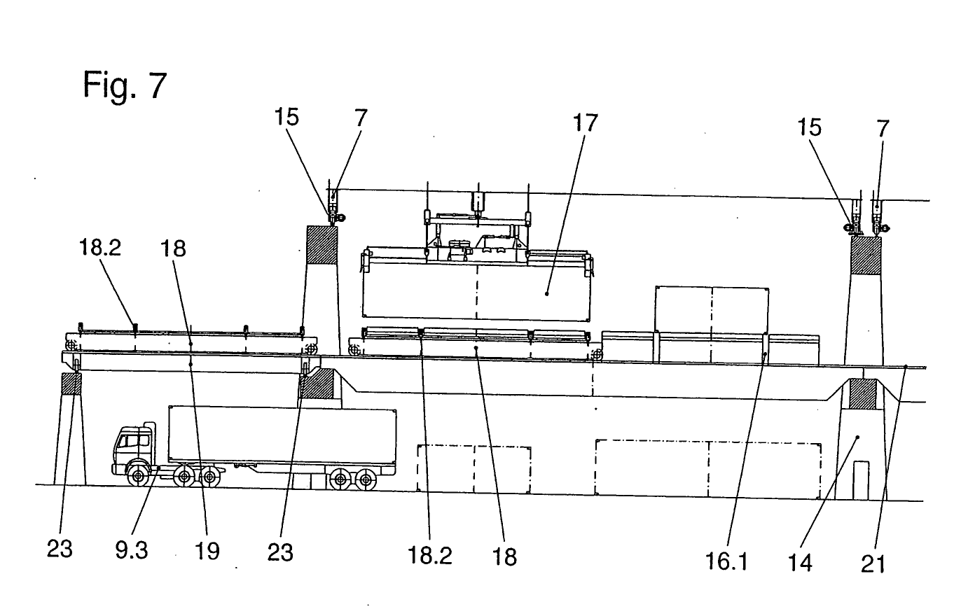

FIG. 7, a side view of the yard entrance and exit, and

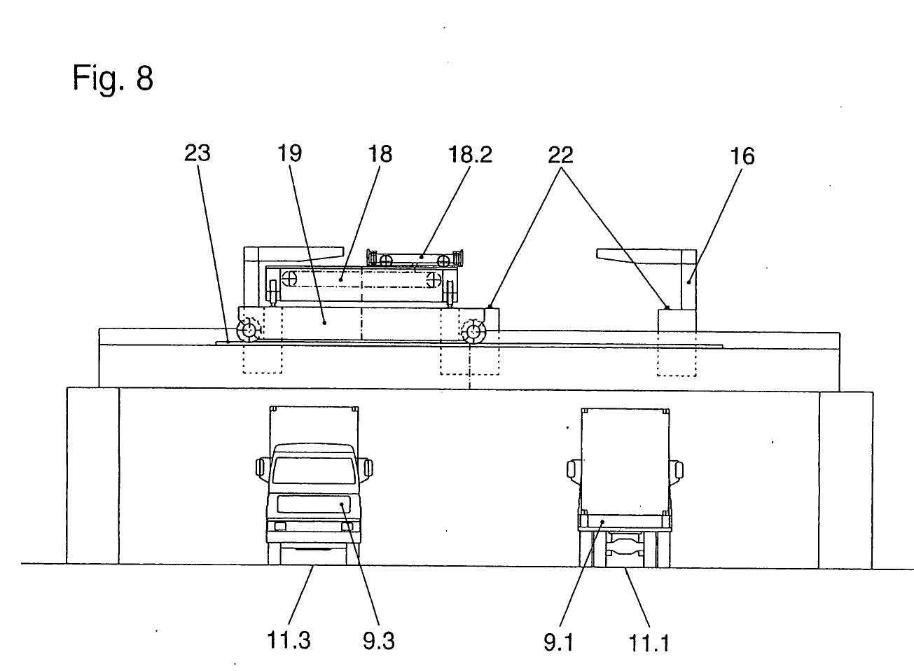

FIG. 8, a front view of the change-over device at the yard entrance and exit.

FIG. 1 shows in a perspective drawing a compact container terminal 1 and a container ship 3 lying at dock 2. Mobile harbor cranes 4 load and unload the containers 5 and transport them to and from the transfer station 6. The transfer station forms the interface between the stacking crane 7 and the mobile harbor cranes 4. The number of stacking cranes used per storage module 8 depends on the particular length of the storage module 8. Trucks 9 are guided through the terminal gate 10 via the truck driveway 11 to the yard entrance or exit 12, through the storage modules 8 onto the turning station 13, and back again to the terminal gate. On the way between the yard entrance or exit 12 and the turning station 13, the trucks are loaded and unloaded at the loading stations assigned by the operating personnel.

FIG. 2 shows in a detail from FIG. 1 a truck 9 at the yard entrance or exit 12 on its way to a loading or unloading station, which has been assigned to it at the terminal gate by the attendant. Furthermore, one recognizes two stacking cranes 7 on the railways 15 of the storage module 8, which are elevated by means of pillars 14. The interim storage stations 16, which are angular in cross section, form a kind of bracket and serve as a support for the containers 17. One can notice the driving up of a cross transporter 18 to the first change-over device 19.

FIG. 3 shows the turning station 13 with the truck driveway 11. Furthermore, one notices a stacking crane 7 on the railway 15 of the storage module 8, which is elevated by means of pillars 14. The interim storage stations 16, which are angular in cross section, serve as a support and buffer for the containers 17 and form the interface between the stacking crane 7 and the cross transporter 18. The cross transporter 18, which is located at the second change-over device 20, is changing railway at the moment.

FIG. 4 is a detail from FIG. 1. The figure shows a top view of the container yard in the region of the entrance or exit 12. Depicted is the storage module 8, a truck 9 in the loading lane in the yard exit direction, the craneway supports 14 and a container 17, being kept at the interim storage station 16. The railway 15 of the stacking crane is not shown in this figure. The interim storage station is opened slotwise 16.1 at the standard spacing of the corner fittings of ISO containers.

The cross transporters 18 move on the parallel laid railways 21 and 22 through the container yard. In the region of the yard entrance or exit 12, the first change-over device 19, which travels on a railway 23, enables the switching of the cross transporter from one railway to the other. Position 24 shows one possible direction of travel (here depicted counterclockwise) for the movement of the cross transporters.

Similar to the first change-over device 19 at the yard entrance or exit 12, the second change-over device 20 at the turning station 13 takes over the function of track switching for the cross transporters 18.

FIG. 5 shows a cross section through the interim storage station 16 and a view of the cross transporter 18. One notices the angular shape of the interim storage station 16 and one cross transporter 18 on each of the two railways 21 and 22. A linear drive 18.1 (state of the art) moves the load carrier 18.2 in reversible operation, guided on the railway 18.3, to one of the two end positions, “interim storage station” or “cross transport travel,” depending on the job.

At the left side of FIG. 5 one notices the load carrier 18.2 on the cross transporter 18 in the “cross transport travel” position. Eight hydraulic load supports 18.4 (shown here for 20 foot and 40 foot containers) are provided at the standard spacing of the container corner fittings. The container 17 stands with its corner fittings 17.1 on four nonactivated hydraulic load supports 18.4. In this position, the cross transporter 18 can travel along the railways 21 and 22.

At the right side of the drawing one notices the load carrier 18.2 on the cross transporter 18 in the “interim storage station” position. The container 17 stands with its corner fittings 17.1 on four activated hydraulic load supports 18.4, which penetrate into the slotlike openings in the horizontal angle leg of the interim storage station, arranged at the standard spacing of the container corner fittings. In this position, the interim storage station 16 can be loaded and unloaded.

FIG. 6 shows a cross section through the loading and unloading zone in the container yard. One can recognize the passageway in the transverse direction through a storage module 8. The trucks 9.1 and 9.3 are located on the driving lanes 11.1 and 11.3, the trucks 9.2 and 9.4 on the loading lanes 11.2 and 11.4. The container 17, previously placed in the angle-shaped interim storage station 16, is taken by the stacking crane 7, running on the railway 15, to the truck 9.4 and set down there.

FIG. 7 is a side view of the yard entrance or exit 12. The figure shows the stacking crane 7 on the railway 15, elevated by means of pillars 14, while handling the container 17 at the interim storage station 16. Furthermore, one recognizes the cross transporter 18 on the first railway 21 in the waiting position prior to a possible hand-off of the container. The linear drive of the load carrier 18.2 on the cross transporter pushes the hydraulic load supports, arranged at the standard spacing of the container corner fittings, into the slotlike openings 16.1 of the interim storage station.

A second cross transporter 18 is located at the first change-over device 19. This enables transport via the railway 23 to the parallel running second railway 22. Underneath the railways 21 and 22 and the interim storage station 16, a sufficiently high clearance remains for trucks, such as 9.3. The situation at the turning station 13 with the second change-over device is configured similar to the yard entrance or exit 12.

FIG. 8, finally, shows a front view of the first change-over device 19 at the yard entrance or exit. The figure shows the first change-over device 19 on the railway 23, a cross transporter 18 with its load carrier 18.2 before or after switching track to or from the first railway 22, and the interim storage station 16 which is angular in cross section. Beneath the change-over device 19, trucks 9.1 and 9.3 are represented on the driving lanes 11.1 and 11.3.

### LIST OF REFERENCE SYMBOLS

1 Container terminal
2 Dock
3 Container ship
4 Mobile harbor crane
5 Container aboard the ship
6 Transfer station
7 Stacking crane
8 Storage module
9 Truck
9.1 Truck driving lane IN
9.2 Truck loading lane IN
9.3 Truck driving lane OUT
9.4 Truck loading lane OUT
10 Terminal gate
11 Truck driveway
11.1 Driving lane IN
11.2 Loading lane IN
11.3 Driving lane OUT
11.4 Loading lane OUT
12 Yard entrance or exit
13 Turning station
14 Craneway supports
15 Railway
16 Interim storage station
16.1 Slot opening in the interim storage station
17 Container in the yard
17.1 Container corner fitting
18 Cross transporter
18.1 Linear drive
18.2 Load carrier
18.3 Railway
18.4 Hydraulic load support
19 Change-over device 1 at the yard entrance or exit
20 Change-over device 2 at the turning station
21 Railway 1 for the cross transporter
22 Railway 2 for the cross transporter
23 Railway for the change-over device 1
24 Direction of turning for the cross transporter

1. Handling facility at a seaport or inner harbor, with a container terminal arranged alongside a wharf, said container terminal including individual storage modules arranged in rows, and at least one loading facility interacting with the storage modules for the cargo handling to and from a ship docked at the wharf, said handling facility comprising:
at least one elevated stacking crane per storage module, said at least one elevated stacking crane handling the receiving, the horizontal transporting, and the stacking of the containers;
cross transporters acting independently of each other and able to travel on a different horizontal level transverse to the individual storage modules, said cross transporters being responsible for the horizontal transporting of containers between the storage modules;
more than two of said cross transporters being adapted to move on the same level beneath the transport level of said at least one elevated stacking crane and above Struck loading lanes on at least one railway extending transversely to the storage modules into a region of interim storage stations assigned to each storage modules, each of said interim storage stations being arranged sideways and parallel to said at least one railway and forming interfaces between said at least one elevated stacking crane and said cross transporters.

2. Handling facility according to claim 1, wherein each cross transporter is outfitted with a transfer or receiving device for moving a container from or to an interim storage station.

3. Handling facility according to claim 2, wherein said transfer or receiving device includes a load carrier for the container that can shift or travel into the region of the interim storage station, transverse to the direction of travel of said cross transporter.

4. Handling facility according to claim 3, wherein said load carrier is configured as a linear driven shunt cart, said shunt cart adapted to travel on another railway arranged on said cross transporters.

5. Handling facility according to claim 4, wherein said interim storage stations, are configured as angle brackets and reach at least partially freely across said at least one railway and one said cross transporter so that said load carrier can travel underneath one said interim storage station when said one said cross transporter is positioned underneath that interim storage station and further including sideways running open slots in the horizontal part of the angle bracket in the direction of said load carrier, which said slots engaged by vertical lifting devices for the container, arranged on said load carrier and reaching underneath support points of the container.

6. Handling facility according to claim 5, wherein said vertical lifting devices of the load carrier are configured as hydraulic piston and cylinder units.

7. Handling facility according to claim 6, wherein said at least one railway comprises at least two railways running parallel to each other traverse the container terminal transverse to the storage modules, said at least two railways being joined together at the head end by change-over devices for said one said cross transporter, in order to enable a switching of said one said cross transporter from one of said at least two railways to the other of said at least two railways.

8. Handling facility according to claim 7, including driving lanes for trucks that travel underneath said at least one railway.

9. Handling facility according to claim 8, including loading lanes for trucks that travel underneath alongside the interim storage stations.

10. Handling facility according to claim 7, wherein said cross transporters are timed to travel in a particular direction of turning on said at least two railways and said change-over devices.

11. Handling facility according to claim 7, wherein said change-over devices each include a bridgelike steel structure with lengthwise running railways, whose gauges correspond to those of said at least two railways for the cross transporters, and said change-over devices are provided with rail travel mechanisms at the front end, which can travel on said lengthwise running railways between said at least two railways of the cross transporters that are elevated at the head end transverse to said at least two railways of the cross transporters and move into end positions in which said at least two railways on the bridgelike steel structure are aligned with one of said at least two railways for the cross transporter.

12. Handling facility according to claim 7, wherein said interim storage stations are fastened by the vertical legs of said angle brackets to the side of the girders for said at least two railways and are configured to accommodate up to four containers per storage module.

13. Handling facility according to claim 1, wherein said interim storage stations are configured as angle brackets and reach at least partially freely across said at least one railway and one said cross transporter so that said load carrier can travel underneath one said interim storage station when said one said cross transporter is positioned underneath that interim storage station and further including sideways running open slots in the horizontal part of the angle bracket in the direction of said load carrier, said slots engaged by vertical lifting devices for the container, arranged on said load carrier and reaching underneath support points of the container.

14. Handling facility according to claim 13, wherein said vertical lifting devices of the load carrier are configured as hydraulic piston and cylinder units.

15. Handling facility according to claim 2, wherein said interim storage stations are configured as angle brackets and reach at least partially freely across said at least one railway and one said cross transporter so that said load carrier can travel underneath one said interim storage station when said one said cross transporter is positioned underneath that interim storage station and further including sideways running open slots in the horizontal part of the angle bracket in the direction of said load carrier, said slots engaged by vertical lifting devices for the container, arranged on said load carrier and reaching underneath support points of the container.

16. Handling facility according to claim 15, wherein said vertical lifting devices of the load carrier are configured as hydraulic piston and cylinder units.

17. Handling facility according to claim 3, wherein said interim storage stations are configured as angle brackets and reach at least partially freely across said at least one railway and one said cross transporter so that said load carrier can travel underneath one said interim storage station when said one said cross transporter is positioned underneath that interim storage station and further including sideways running open slots in the horizontal part of the angle bracket in the direction of said load carrier, said slots engaged by vertical lifting devices for the container, arranged on said load carrier and reaching underneath support points of the container.

18. Handling facility according to claim 17, wherein said vertical lifting devices of the load carrier are configured as hydraulic piston and cylinder units.

19. Handling facility according to claim 1, wherein said at least one railway comprises at least two railways running parallel to each other traverse the container terminal transverse to the storage modules, said at least two railways being joined together at the head end by change-over devices for said one said cross transporter, in order to enable a switching of said one said cross transporter from one of said at least two railways to the other of said at least two railways.

20. Handling facility according to claim 1, including driving lanes for trucks that travel underneath said at least one railway.

21. Handling facility according to claim 1, wherein said loading lanes travel underneath alongside the interim storage stations.

22. Handling facility according to claim 19, wherein said cross transporters are timed to travel in a particular direction of turning on said at least one railway and said change-over devices.

23. Handling facility according to claim 19, wherein said change-over devices each include a bridgelike steel structure with lengthwise running railways, whose gauges correspond to those of said at least two railways for the cross transporters, and said change-over devices are provided with rail travel mechanisms at the front end, which can travel on said lengthwise running railways between said at least two railways of the cross transporters that are elevated at the head end transverse to said at least two railways of the cross transporters and move into end positions in which said at least two railways on the bridgelike steel structure are aligned with one of said at least two railways for the cross transporter.

24. Handling facility according to claim 1, wherein said interim storage stations are fastened by the vertical legs of said angle brackets to the side of the girders for said at least two railways and are configured to accommodate up to four containers per storage module.
